(19) United States
(12) Patent Application Publication
(10) Pub. No.: US 2002/0083746 A1
(43) Pub. Date: Jul. 4, 2002

(54) Self-retracting remotely operated bicycle lock

(76) Inventors: Brian David Cleveland, Boulder, CO (US); Anthony Carino Pigliacampo, Boulder, CO (US)

Correspondence Address: JENNIFER L. BALES, MOUNTAIN VIEW PLAZA, 1520 EUCLID CIRCLE, LAFAYETTE, CO, 80026-1250, US

(21) Appl. No.: 10/015,283

(22) Filed: Dec. 10, 2001

Related U.S. Application Data
(60) Provisional application No. 60/255,018, filed on Dec. 12, 2000.

(51) Int. Cl. E05B 71/00

(52) U.S. Cl. 70/233

(57) ABSTRACT

A self retracting, remotely operated bicycle lock includes a lock body having a lock aperture and a lock device, a mechanism for unlocking the lock device, a cable attached within the lock body, the cable uncoiled from the lock body by tension and having a latching end element at the outer, uncoiled end, and a reel assembly for retracting the cable into the lock body. The lock device engages the latching end element when the latch element is inserted into the lock aperture. The unlocking mechanism disengages the lock device from the latching element to unlock the lock upon receiving a remote signal, and the reel assembly retracts the cable.

This application claims the benefit of U.S. Provisional Application No. 60/255,018, filed Dec. 12, 2000.

### BACKGROUND OF THE INVENTION

1. Field of the Invention

The present invention relates to a self-retracting remotely operated bicycle lock.

2. Description of the Prior Art

When an owner of a bicycle leaves it in a public place, the owner typically locks the bike to a bike rack, a pole, or some other fixed object using a chain or cable with a padlock or similar lock. Unlocking the bike then requires fumbling with keys or a combination to unlock the lock, and then removing and coiling up the cable.

While new automobiles generally included remotely operated locks, bicycle locks do not include this feature. It would not be especially useful to remotely unlock a conventional bicycle lock, since the bicycle owner would still need to remove and coil up the cable.

A need remains in the art for a self-retracting remotely operated bicycle lock.

### SUMMARY OF THE INVENTION

The present invention is a self retracting, remotely operated bicycle lock.

The self-retracting lock includes a lock body having a lock aperture and a lock device, a mechanism for unlocking the lock device, a cable attached within the lock body, the cable uncoiled from the lock body by tension and having a latching end element at the outer, uncoiled end, and a reel assembly for retracting the cable into the lock body. The lock device engages the latching end element when the latch element is inserted into the lock aperture. The unlocking mechanism disengages the lock device from the latching element to unlock the lock upon receiving a remote signal, and the reel assembly retracts the cable.

In a preferred embodiment, the latching end element includes a recess, and the lock device includes a lock pin which is biased to insert into the recess to engage the latching end element. The latching end element forces the biased lock pin to retract upon insertion of the latching end element into the lock aperture, and the lock pin subsequently engages the recess when the recess aligns with the lock pin.

The unlocking mechanism includes control circuitry for receiving the remote signal and generating an unlock signal, and an actuator which momentarily retracts the pin upon receiving the unlock signal from the control circuitry. A biasing element pushes the latching end element out toward the opening of the lock aperture, to prevent the pin from engaging the recess again.

Preferably, the reel assembly comprises an axle rotatably attached between two spring assemblies. The axle is configured to rotate in a forward direction as the cable is uncoiled, and the spring assemblies are biased to rotate the axle in a reverse direction, thereby retracting the cable. The spring assemblies might include flat recoiling springs, with the axle having arms attached to an end of each recoiling spring. The axle might further include a slot for insertion of the inner end of the cable.

Preferably, the lock is configured to fit into a conventional water bottle mount.

### DETAILED DESCRIPTION OF THE PREFERRED EMBODIMENT

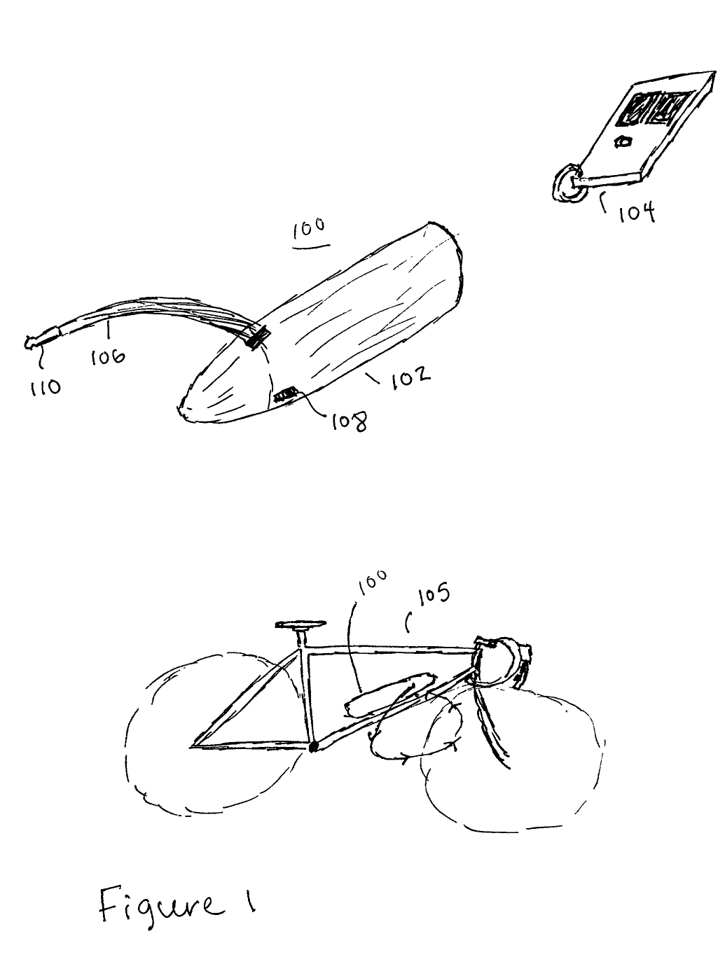

FIG. 1 is an isometric view showing a self retracting remotely operated bicycle lock 100 according to the present invention, along with a remote control 104 for unlocking lock 100, and a preferred configuration of lock 100 with bicycle 105. Lock 100 includes a body 102, a cable 106 with a latching element 110 at the end, and an aperture 108 for the latching mechanism. Remote 104 preferably transmits an encoded infrared (IR) signal to unlock lock 100. Lock 100 preferably fits into existing water bottle mounts that are standard on most bicycles.

When the rider dismounts, the rider pulls cable 106 out of lock 100, wraps it around a bike rack or other object (not shown), and inserts latching element 110 into aperture 108 to lock the lock, and leaves. When the rider returns, the rider presses the button on remote 104, lock 100 releases and retracts cable 106, and the rider rides off. The rider does not have to touch the lock or the cable.

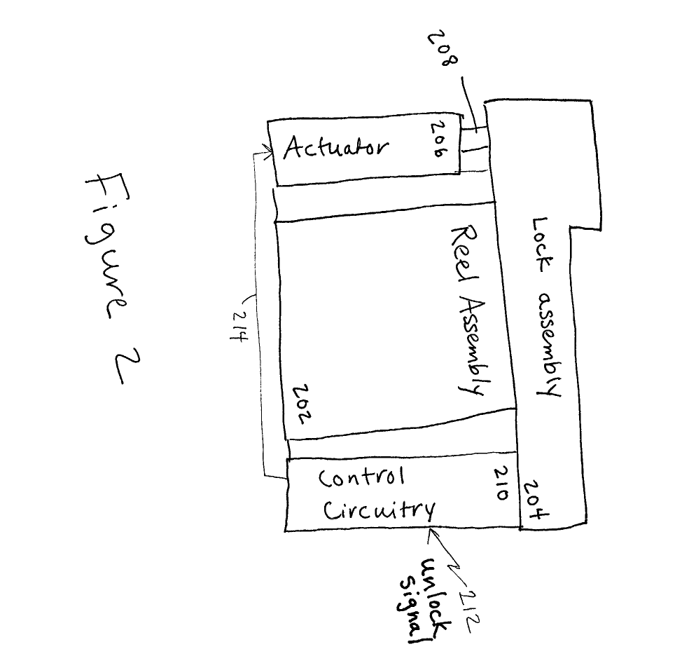

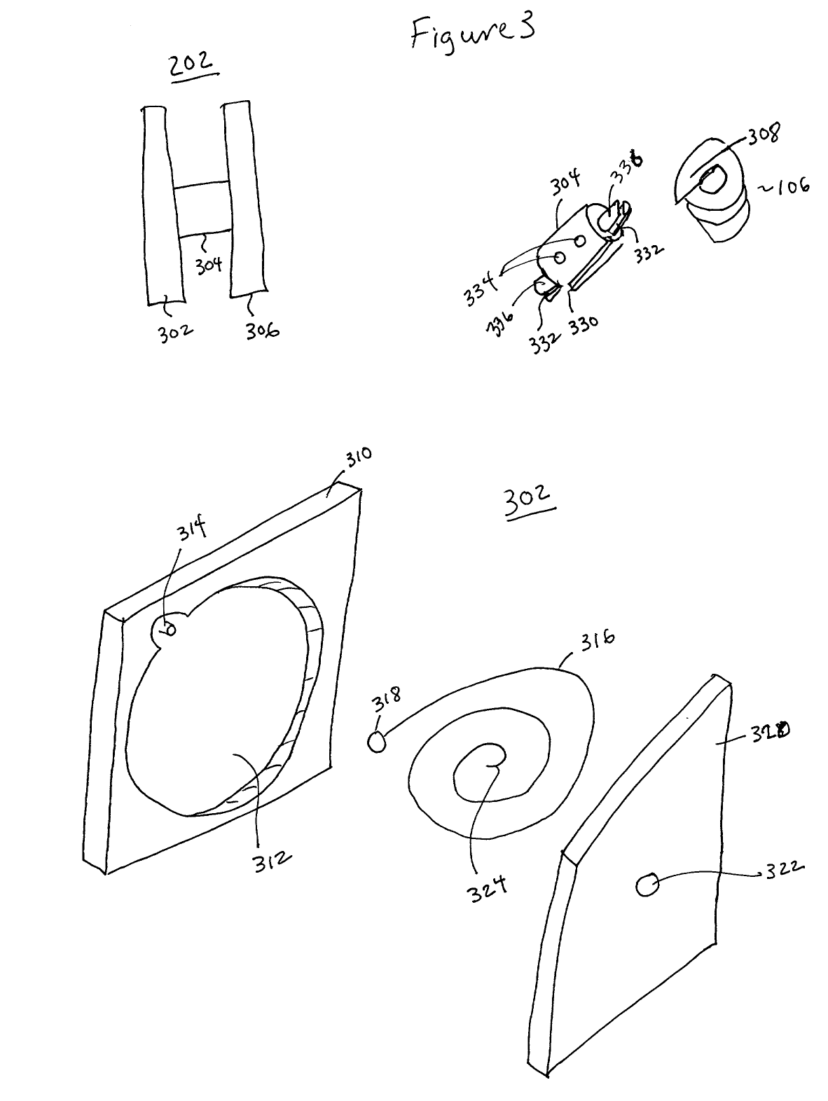

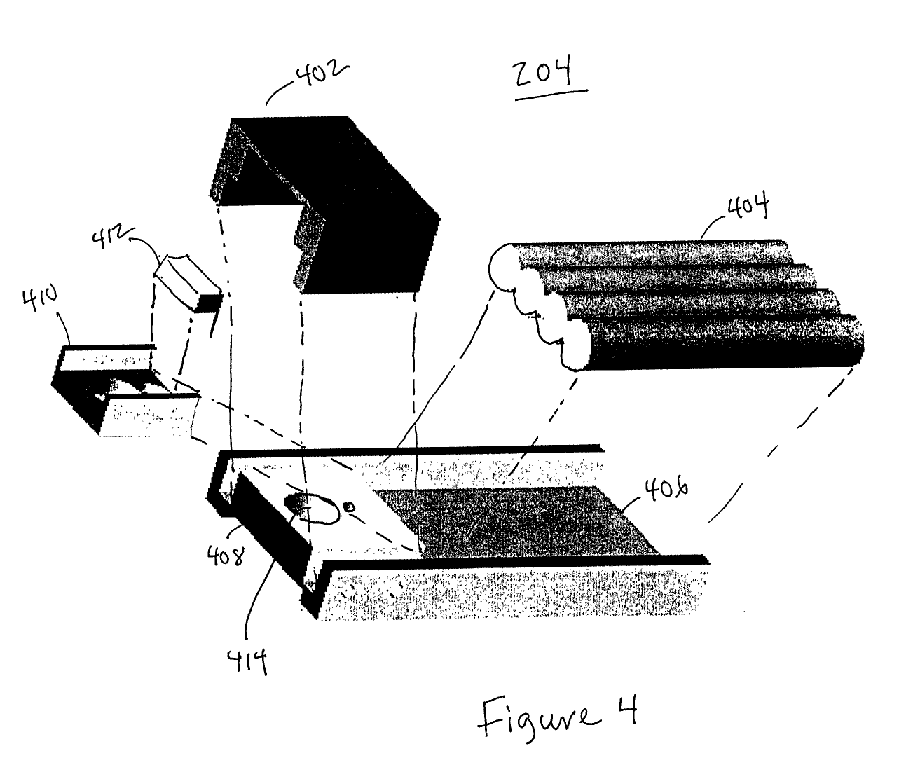

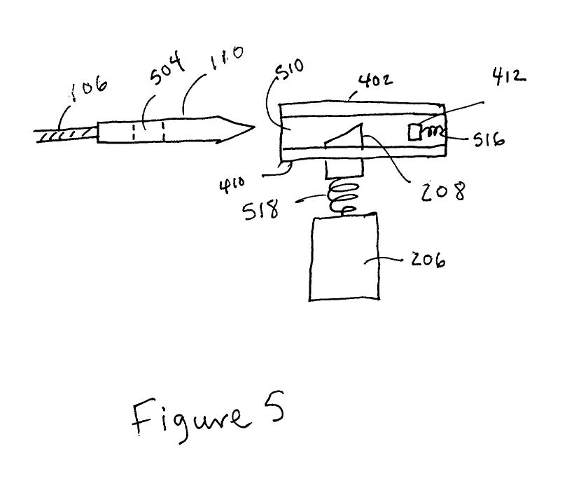

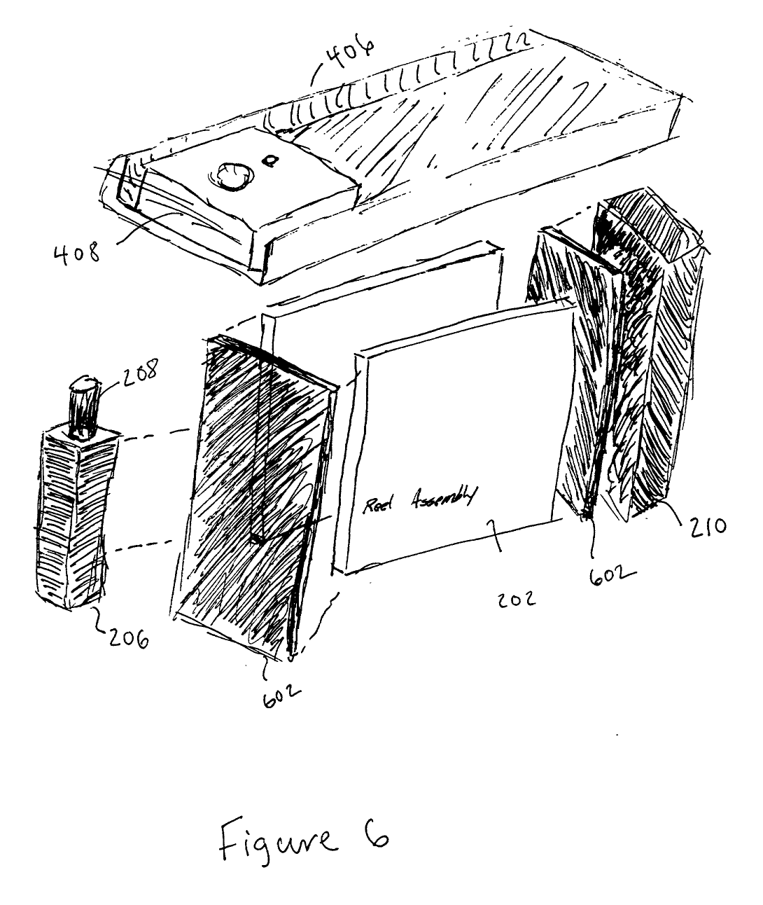

FIG. 2 is a block diagram showing the elements of lock 100 which are contained within body 102. Reel assembly 202 is shown in more detail in FIG. 3. Lock assembly 204 is shown in more detail in FIG. 4. The operation of actuator 206, lock pin 208, and the locking mechanism of lock assembly 204 is shown in more detail in FIG. 5. FIG. 6 illustrates how some of the parts of lock 100 come together in a preferred embodiment.

Briefly, control circuitry 210 receives a signal 212 (preferably an IR signal) from remote 104. Upon determining that it has received the correct signal, control circuitry 210 directs actuator 206 to actuate via control signal 214. Actuator 206 momentarily retracts pin 208, releasing latching element 110. Reel assembly 202 retracts cable 106.

FIG. 3 is an isometric drawing illustrating the elements of reel assembly 202. Reel assembly 202 includes axle 304, two spring assemblies 302, 306, which cause axle 304 to spin, and retracting cable 106.

Axle 304 preferably includes a slot 330 for insertion of one end 308 of cable 106, and two holes 334 to allow end 308 to be riveted or bolted to axle 304. Extending from axle 304 are two cylindrical arms 336, each having a slot 332. Slots 332 will attach to spring assemblies 302, 306 allowing them to rotate axle 304.

Spring assemblies 302 and 306 are preferably mirror images of each other, so only spring assembly 302 is shown in detail and described here. Spring assembly 302 includes case elements 310 and 320, and flat recoil spring 316. Case element 310 includes a recess 312 to house spring 316, and a pin 314 to fixedly attach an end 318 of spring 316 to case element 310. Case element 320 may incorporate a similar recess, or be flat.

Case element 320 forms an aperture 322. An arm 336 of axle 304 extends through aperture 322 and end 324 of spring 316 is inserted into slot 332 of this arm 336. Thus, as cable 106 is withdrawn from lock 100, axle 304 rotates, and spring 316 tightens. When cable 106 is released, spring 316 recoils to its normal configuration, causing axle 304 to rotate the other way, and cable 106 to retract and wind up onto axle 304. In the preferred embodiment, spring assembly 306 is identical to spring element 302, so that two recoil springs 316 act upon axle 304. In the preferred embodiment, cable 106 is a flat braided aluminum cable, but a variety of cable types could be used, or even certain types of chain or rope.

FIG. 4 is an isometric drawing illustrating the elements of lock assembly 204. Lock assembly 204 includes base 406 having an integral lock base 408, battery 404, lock plate 410, which engages, hole to hole, with lock base 408, lock release pin 412, and lock cover 402. Battery 404 powers control circuitry 210 and actuator 206. Release pin 412 is biased toward the opening 510 formed by lock cover 402 and lock plate 410 by a spring 516 (see FIG. 5).

Latching element 110 is inserted into the opening 510 formed by lock cover 402 and lock plate 410. Bore 414 will allow pin 208 to extend up into opening 510 and secure latching element 110.

FIG. 5 is a side cutaway drawing illustrating the operation of actuator 206, lock pin 208, relevant portions of lock assembly 204, cable 106 and latching end element 110. The elements are shown functionally and not to scale. Latching end element 110 includes a recess 504. When latching end element 110 is inserted into opening 510, pin 208 is pushed down out of the way by latching end element 110. Spring 518 biases pin 208 upward, so that when recess 504 is located over pin 512, pin 208 moves into recess 504, locking the lock. To unlock the lock, actuator 206 momentarily retracts pin 208. Release pin 412, biased by spring 516, pushes latching end element 110 outward, and, along with the recoiling action of spring 316, prevents relocking.

FIG. 6 is a side isometric drawing showing how several of the elements of lock 100 come together in the preferred embodiment. Reel assembly 202 is positioned between control circuitry 210 and actuator 206. Lock pin 208 is aligned to hole 414 in lock base 408 of lock assembly base 406. Elements 602 are housing brackets.

While the exemplary preferred embodiments of the present invention have been described in detail, those skilled in the art will recognize various changes, modifications, additions, and applications other than those specifically mentioned herein which fall within the spirit of this invention.

What is claimed is:

1. A self-retracting lock unlocked by a remote signal comprising:
a lock body having a lock aperture and a lock device;
a mechanism for unlocking the lock device;
a cable attached within the lock body, the cable uncoiled from the lock body by tension, and having a latching end element at the outer, uncoiled end;
a reel assembly for retracting the cable into the lock body;
wherein the lock device engages the latching end element when the latch element is inserted into the lock aperture; and
wherein the mechanism disengages the lock device from the latching element to unlock the lock upon receiving the remote signal, and the reel assembly subsequently retracts the cable.

2. The lock of claim 1, wherein the latching end element includes a recess, and the lock device includes a lock pin which is biased to insert into the recess to engage the latching end element.

3. The lock of claim 2, wherein the latching end element forces the biased lock pin to retract upon insertion of the latching end element into the lock aperture, and wherein the lock pin subsequently engages the recess when the recess aligns with the lock pin.

4. The lock of claim 3, wherein the mechanism includes:
control circuitry for receiving the remote signal and generating an unlock signal; and
an actuator which retracts the pin from the recess upon receiving the unlock signal from the control circuitry.

5. The lock of claim 4, further including a biasing element for pushing the latching end element out toward the opening of the lock aperture, to prevent the pin from re-engaging the recess.

6. The lock of claim 1, wherein:
the reel assembly comprises an axle rotatably attached between two spring assemblies;
the axle is configured to rotate in a forward direction as the cable is uncoiled; and
the spring assemblies are biased to rotate the axle in a reverse direction, thereby retracting the cable.

7. The lock of claim 6 wherein the spring assemblies include flat recoiling springs, and wherein the axle includes arms attached to an end of each recoiling spring.

8. The lock of claim 7 wherein the axle further comprises a slot for insertion of the inner end of the cable.

9. The lock of claim 1, wherein the mechanism includes:
control circuitry for receiving the remote signal and generating an unlock signal; and
a mechanical apparatus which disengages the lock device from the latching element upon receiving the unlock signal from the control circuitry.

10. The lock of claim 1, wherein the lock is configured to fit into a conventional water bottle mount.

11. A self-retracting bicycle lock system comprising:
a remote control for generating an unlock signal;
a lock body having a lock aperture and a lock device;
a mechanism for unlocking the lock device;
a cable attached within the lock body, the cable uncoiled from the lock body by tension, and having a latching end element at the outer, uncoiled end;
a reel assembly for retracting the cable into the lock body;
wherein the lock device engages the latching end element when the latch element is inserted into the lock aperture; and
wherein the mechanism disengages the lock device from the latching element to unlock the lock upon receiving the unlock signal, and the reel assembly subsequently retracts the cable.

12. The lock of claim 11, wherein the latching end element includes a recess, and the lock device includes a lock pin which is biased to insert into the recess to engage the latching end element.

13. The lock of claim 12, wherein the latching end element forces the biased lock pin to retract upon insertion of the latching end element into the lock aperture, and wherein the lock pin subsequently engages the recess when the recess aligns with the lock pin.

14. The lock of claim 13, wherein the mechanism includes:
control circuitry for receiving the remote signal and generating an unlock signal; and
an actuator which retracts the pin from the recess upon receiving the unlock signal from the control circuitry.

15. The lock of claim 14, further including a biasing element for pushing the latching end element out toward the opening of the lock aperture, to prevent the pin from re-engaging the recess.

16. The lock of claim 1, wherein:
the reel assembly comprises an axle rotatably attached between two spring assemblies;
the axle is configured to rotate in a forward direction as the cable is uncoiled; and
the spring assemblies are biased to rotate the axle in a reverse direction, thereby retracting the cable.

17. A self-retracting lock unlocked by a remote signal comprising:
a lock body having a lock aperture and a lock device;
a cable attached within the lock body, the cable uncoiled from the lock body by tension, and having a latching end element at the outer, uncoiled end;
wherein the latching end element includes a recess, and the lock device includes a lock pin which is biased to insert into the recess to engage the latching end element;
a mechanism for unlocking the lock device including control circuitry for receiving the remote signal and generating an unlock signal, and an actuator which retracts the pin from the recess upon receiving the unlock signal from the control circuitry;
a reel assembly for retracting the cable into the lock body;
wherein the lock device engages the latching end element when the latch element is inserted into the lock aperture; and
wherein the mechanism disengages the lock device from the latching element to unlock the lock upon receiving the remote signal, and the reel assembly subsequently retracts the cable.

18. The lock of claim 17, wherein the latching end element forces the biased lock pin to retract upon insertion of the latching end element into the lock aperture, and wherein the lock pin subsequently engages the recess when the recess aligns with the lock pin.

19. The lock of claim 17, further including a biasing element for pushing the latching end element out toward the opening of the lock aperture, to prevent the pin from re-engaging the recess.

20. The lock of claim 17, wherein:
the reel assembly comprises an axle rotatably attached between two spring assemblies;
the axle is configured to rotate in a forward direction as the cable is uncoiled; and
the spring assemblies are biased to rotate the axle in a reverse direction, thereby retracting the cable.
